(19) United States
(12) Patent Application Publication
(10) Pub. No.: US 2020/0275022 A1
(43) Pub. Date: Aug. 27, 2020

(54) AUTOMOTIVE DRIVING RECORDER

(71) Applicant: Lumileds LLC, San Jose, CA (US)

(72) Inventors: Chao Shang, Shanghai (CN); Pei Yang, Shanghai (CN); Shichun Liu, Shanghai (CN); Huihua Chen, Shanghai (CN); Xuejun Zhang, Shanghai (CN); Yangguang Zhao, Changsu (CN); Harry Han, Shanghai (CN)

(21) Appl. No.: 16/647,197

(22) PCT Filed: Sep. 6, 2018
(86) PCT No.: PCT/EP2018/074015

§ 371 Date: Mar. 13, 2020

(30) Foreign Application Priority Data
Sep. 15, 2017 (CN) PCT/CN2017/101884
Oct. 18, 2017 (EP) 17196981.9

(51) Int. Cl. H04N 5/232; H04N 5/225; H04N 5/235; H04N 5/76; H04N 7/18

(52) U.S. Cl. CPC H04N 5/23238; H04N 5/2258; H04N 5/2253; H04N 5/2254; H04N 5/23296; H04N 5/76; H04N 7/18; H04N 5/232933; H04N 5/2353

(57) ABSTRACT

This disclosure provides an automotive driving recorder for being installed on an automobile, comprising: a body; a first lens mounted on a front portion of the body, facing in the forward direction of an automobile when installed to record first videos; a second lens mounted on a rear portion of the body, facing in the backward direction of the automobile when installed to record second videos; a first sensor, mounted in the body for determining exposure settings of the first lens; and a second sensor, mounted in the body for determining exposure settings of the second lens independently from the first sensor.

### TECHNICAL FIELD

The present invention relates to a technical field of automobile, and more particularly to an automobile driving recorder.

### BACKGROUND

An automotive driving recorder is generally an onboard camera that continuously records the view through a vehicle's windscreen. It may be attached to the interior windscreen or to the top of the dashboard, by suction cup or adhesive-tape mount. Automotive driving recorders may provide video evidence in the event of an accident.

Various types of automotive driving recorders are available on the market, ranging from basic video cameras to ones which also record parameters such as date/time, speed, G-forces and location. Most of these automotive driving recorders put emphasis on capturing what is happening outside an automobile. According to market research, requirement for capturing everything happening inside and outside the automobile is growing, wonderful moments inside the automobile, especially during self-driving travelling involving family members or friends, are also expected to be recorded.

The state of the art has already reacted on such demand by offering automotive driving recorders with at least a front lens and a rear lens, with US20160381292A1 providing an example with a rotatably mounted rear lens, and with EP3190780A1 providing a processing unit for merging the images of the front and rear lenses to a single view covering a sphere.

These driving recorders treat the images captured by the front and rear lenses in a common way. But with the lighting conditions possibly being much different between the out-of-automobile and the in-automobile scenes, in some situations, the recorded images are of poor quality only. E.g., on a bright day, the outside environment will be much brighter than the automobile interior. This creates the problem that the image of the outside will be much too bright with poor, blurred contrast, while the image of the interior will be much too dark, not allowing to recognize any details and, in extreme situation, even lacking color resolution. See FIG. 1 for an example.

### SUMMARY

An object of the present invention is to provide an automotive driving recorder for capturing everything happening inside and outside a vehicle or, at least, for improving such capturing.

Another object of the present invention is to provide an automotive driving recorder for capturing everything happening inside and outside a vehicle both clearly.

Accordingly, in order to accomplish either of the above objects, according to one embodiment of the present disclosure, there is provided an automotive driving recorder for being installed on an automobile, comprising: a body; a first lens mounted on a front portion of the body, facing in the forward direction of the automobile when installed to record first videos; a second lens mounted on a rear portion of the body, facing in the backward direction of the automobile when installed to record second videos; a first sensor, mounted in the body for determining exposure settings of the first lens; and a second sensor, mounted in the body for determining exposure settings of the second lens independently from the first sensor.

Optionally, the automotive driving recorder further comprises: an application in communication with the body, for stitching the first videos and the second videos to form stitched videos of 360°.

Optionally, the first lens and the second lens are wide-angle lenses.

Optionally, an angle of the first lens or of the second lens or of the first and second lenses is 190°.

Optionally, in a private working mode, only the first lens of the two lenses works.

Optionally, in a virtual reality working mode, virtual reality videos are generated.

Optionally, in a babyzoomer mode, only the second videos are rendered, in a zoomed-in size.

Optionally, the automotive driving recorder further comprises a storage, mounted in the body, capable of storing emergency videos that will not be overwritten by new videos automatically, in response to an emergency trigger.

Optionally, the automotive driving recorder further comprises an emergency recording button on the body, when pushed, generating the emergency trigger.

Optionally, the automotive driving recorder further comprises an accelerometer, mounted in the body, configured for detecting an automobile collision, and wherein, in response to such detecting, the emergency trigger is generated.

Optionally, the automotive driving recorder is further configured to enable alerting dependent on a driving fatigue index which is based on a series of physiological and journey related parameters.

Optionally, the automotive driving recorder further comprises a communication interface on the body, and wherein the application is run remotely on a user equipment which is independent from the body, and communicates with the body wirelessly via the communication interface.

Optionally, languages are synchronized from the user equipment via the communication interface.

Optionally, the application comprises a user interface displayed on the user equipment, where a user can choose to view the stitched videos in a desired field of view.

Optionally, the choosing is done by pointing the user equipment towards a direction or by inputting requests via the user interface by the user.

As a whole or by scenario, comparing to the prior art, the stitched videos of 360° for an automobile driving recorder in embodiments of our disclosure greatly improves user experiences in both driving and reviewing.

Further, embodiments of our disclosure have shown a greatly improved video quality with proper exposure settings at least for the front lens and the rear lens. One can see videos of the outside and also videos of the interior clearly.

### BRIEF DESCRIPTION OF THE DRAWINGS

The technology will now be described, by way of example, based on embodiments with reference to the accompanying drawings, wherein:

FIG. 1 illustrates a rendered picture of an automotive driving recorder with at least a front lens and a rear lens according to the prior art.

FIG. 2 is a front view of an automotive driving recorder according to an embodiment of the present invention.

FIG. 3 is a rear view of the automotive driving recorder according to the embodiment of the present invention.

FIG. 4 is a left view of the automotive driving recorder according to the embodiment of the present invention.

FIG. 5 is a right view of the automotive driving recorder according to the embodiment of the present invention.

FIG. 6 is a top view of the automotive driving recorder according to the embodiment of the present invention.

FIG. 7 is a bottom view of the automotive driving recorder according to the embodiment of the present invention.

FIG. 8 is a perspective view of the automotive driving recorder according to the embodiment of the present invention.

FIG. 9 is a schematic view of the automotive driving recorder according to the embodiment of the present invention.

FIG. 10 illustrates a full screen user interface in a first working mode of the automotive driving recorder according to the embodiment of the present invention.

FIG. 11 illustrates a full screen user interface in a second working mode of the automotive driving recorder according to the embodiment of the present invention.

FIG. 12a illustrates a normal user interface in a third working mode from a field of view of the co-pilot position.

FIG. 12b illustrates a normal user interface in a third working mode from a field of view of the driving position.

FIG. 13 illustrates an installation of the automotive driving recorder according to the embodiment of the present invention.

FIG. 14 illustrates a user interface of the automotive driving recorder according to the embodiment of the present invention.

### DETAILED DESCRIPTION

Embodiments herein will be described in detail hereinafter with reference to the accompanying drawings, in which embodiments are shown. These embodiments herein may, however, be embodied in many different forms and should not be construed as being limited to the embodiments set forth herein. The elements of the drawings are not necessarily to scale relative to each other. Like numbers refer to like elements throughout.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

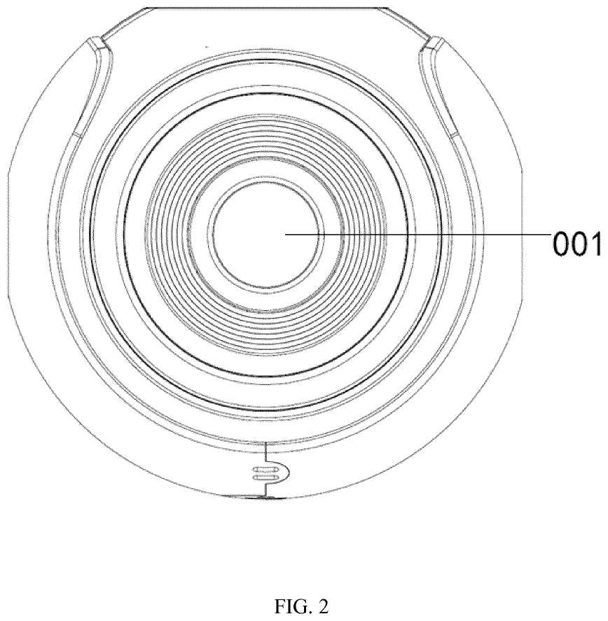

Generally, FIG. 2-7 illustrate the body 910 of the automotive driving recorder, and other accessories, such as bracket for installing the automotive driving recorder, charger for powering the automotive driving recorder, etc., are described below, but may not be illustrated in the figures.

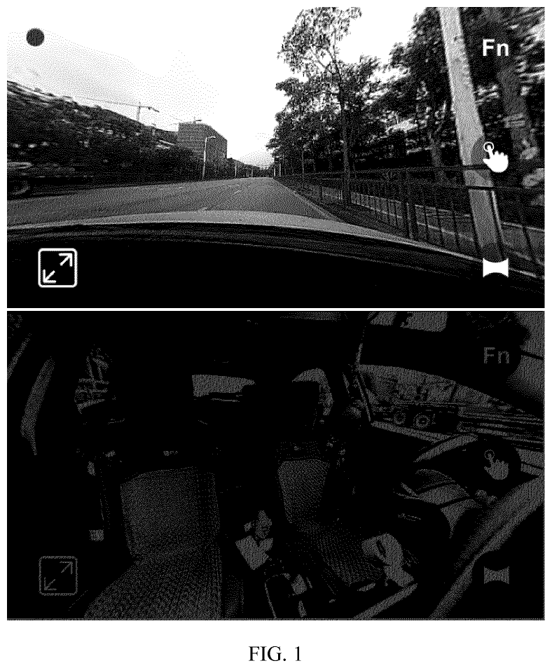

FIG. 1 illustrates a rendered picture of an automotive driving recorder with at least a front lens and a rear lens according to the prior art. Image data from the front lens and the rear lens are displayed separately (the above from the front lens and the below from the rear lens). Obviously, the below is too dark to be seen clearly.

FIG. 2 is a front view of an automotive driving recorder according to an embodiment of the present invention. A front lens 001 is shown therein. The front lens records the environment in front of the automobile, such as oncoming traffic, pedestrians at the road border, etc.

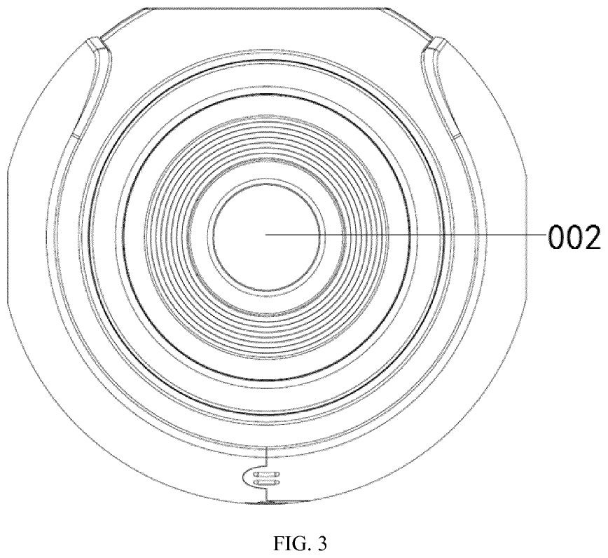

FIG. 3 is a rear view of the automotive driving recorder according to the embodiment of the present invention. A rear lens 002 is shown therein. The rear lens records the automobile interior, such as the driver, the passengers, etc., and probably also some side views outside the automobile.

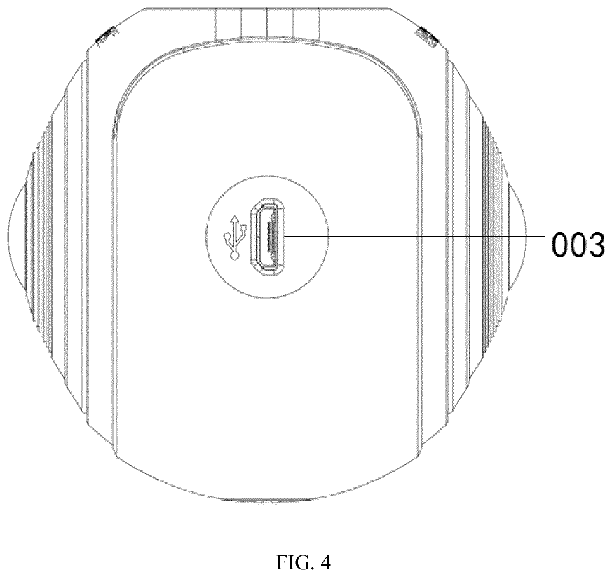

FIG. 4 is a left view of the automotive driving recorder according to the embodiment of the present invention. An interface 003 is shown therein. In one example, the interface 003 is used to interface a power line (not shown) to provide power to the automotive driving recorder. Alternatively or additionally, the interface 003 is used to interface a data line (not shown).

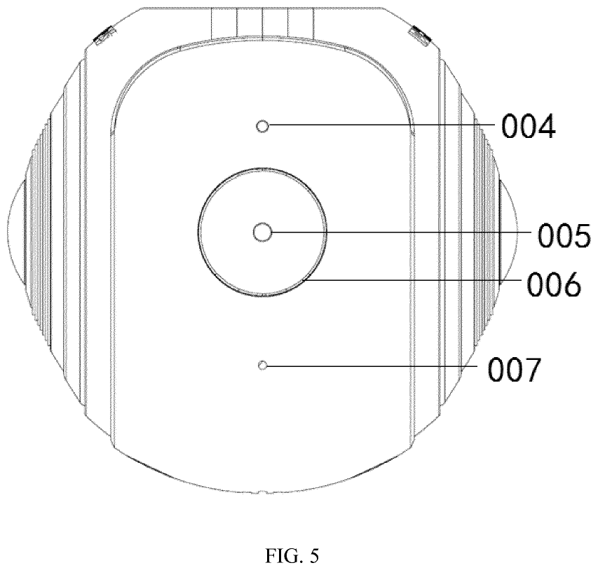

FIG. 5 is a right view of the automotive driving recorder according to the embodiment of the present invention. In one example, as is shown, the automotive driving recorder comprises a wireless connection indicator 004. In a further example, green light slow blinking of the wireless connection indicator 004 represents a status of the automotive driving recorder waiting for connection to a user equipment, green light on of the wireless connection indicator 004 represents a status of the automotive driving recorder being wirelessly connected to a user equipment, and green light fast blinking of the wireless connection indicator 004 represents a status of the automotive driving recorder in a status of data transmission. The wireless connection can be a Wi-Fi connection, an NFC connection, a Bluetooth connection, and any other wireless connection that can be used to facilitate data transmission between the automotive driving recorder and the user equipment. In one example, as is shown, the automotive driving recorder comprises a record status indicator 005. In a further example, blue light on of the record status indicator 005 indicates a status of the automotive driving recorder recording, blue light off of the record status indicator 005 indicates a status of the automotive driving recorder not recording, and breathing light blinking of the record status indicator 005 indicates a status of the automotive driving recorder in an Emergency recording. An emergency recording means a recording occurring in a case of emergency, for example, in response to an emergency trigger, such as detection of a traffic collision, pushing a button (the emergency button 006 as shown in FIG. 5) on the automotive driving recorder manually by a user. The recorded videos in the emergency recording can be stored in a separate folder that is kept away from being erased, so that it can be stored on a long term basis, for future use as evidence. In one example, the automotive driving recorder comprises a microphone 007 to receive sound for recording.

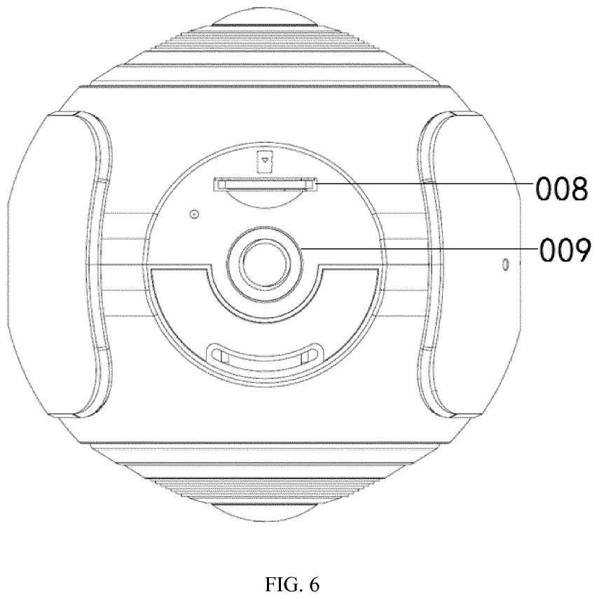

FIG. 6 is a top view of the automotive driving recorder according to the embodiment of the present invention. In one example, as is shown, the automotive driving recorder comprises a storage card slot 008 for inserting a storage card. The storage card can be a MicroSD card, or any other card that may facilitate storage of data such as videos. In one example, as is shown, the automotive driving recorder comprises an install interface, such as a screw socket 009, for the body of the automotive driving recorder to be installed on a bracket (not shown) which is further fixed to a windshield.

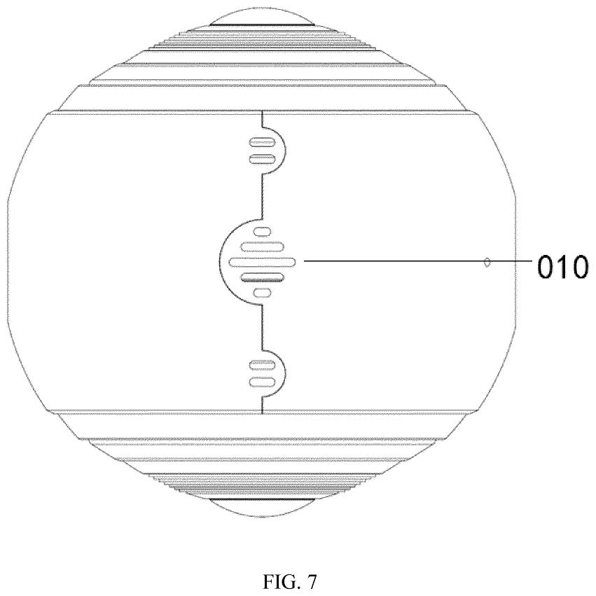

FIG. 7 is a bottom view of the automotive driving recorder according to the embodiment of the present invention. In one example, as is shown, the automotive driving recorder comprises a loudspeaker 010. The automotive driving recorder may output some alerts via the loudspeaker 010.

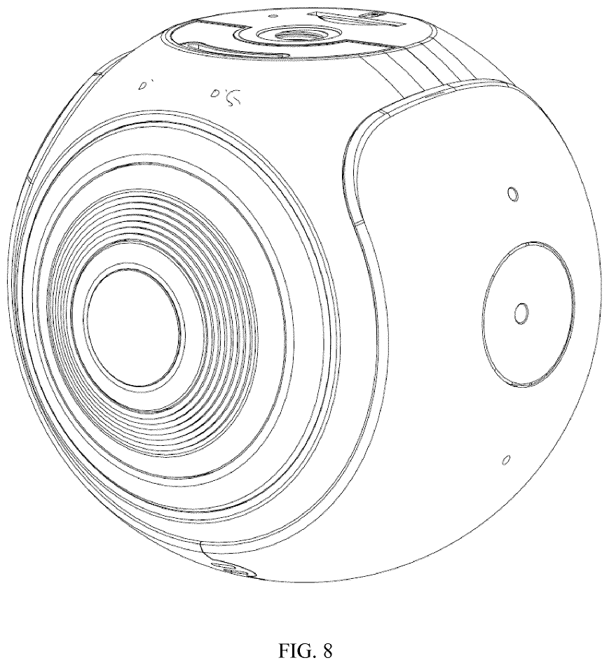

FIG. 8 is a perspective view of the automotive driving recorder according to the embodiment of the present invention. As is shown, the body of the automotive driving recorder according to the embodiment of the present invention is substantially spherical.

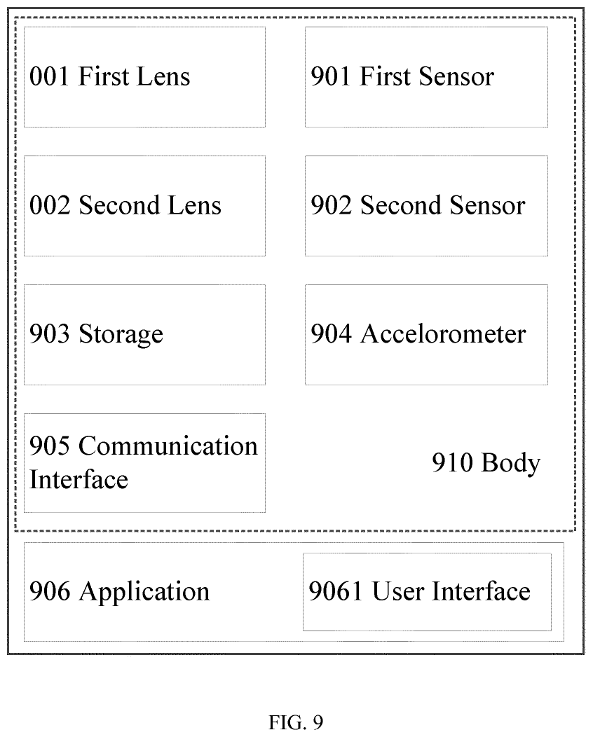

FIG. 9 is a schematic view of the automotive driving recorder according to the embodiment of the present invention. As is shown, the automotive driving recorder comprises a front lens 001 and a rear lens 002. The front lens 001 is mounted on a front portion of the body 910 of the automotive driving recorder, facing forward of an automobile when installed to record first videos. The rear lens 002 is mounted on a rear portion of the body 910 of the automotive driving recorder, facing backward of the automobile when installed to record second videos. Further, the automotive driving recorder comprises a first sensor 901 for determining exposure settings of the front lens and a second sensor 902 for determining exposure settings of the rear lens independently from the first sensor 901.

The first sensor 901 and/or the second sensor 902 can be a CMOS (complementary metal oxide semiconductor) image sensor, for example, a 4 Mega-pixels CMOS sensor. In an alternate example, the first sensor 901 and/or the second sensor 902 can be a CCD image sensor. Generally, a CCD image sensor has the advantage of higher sensitivity, lower noise, and larger signal to noise ratio, but also the disadvantage of complex production process, higher cost, and higher power consumption, while a CMOS image sensor has the advantage of high integration, lower power consumption, and lower cost.

Due to two image sensors determining exposure settings independently for the two lenses, rather than the two lenses sharing the same exposure settings, video quality is greatly improved.

Alternatively or additionally, the application 906 is run in the body of the automotive driving recorder, with or without the same running in the user equipment.

It is noted that the number of user equipment that can run the application to view the videos is not limited to only one.

Alternatively or additionally, the automotive driving recorder comprises an application 906 running remotely on a user equipment and in communication with the body 910, for stitching the first videos from the front lens 001 and the second videos from the rear lens 002 to form stitched videos of 360°.

Alternatively or additionally, the first lens 001 and the second lens 002 are wide-angle lenses, for example, 190° fisheyes lenses. In this way, side views of the automobile through side windows can also be recorded, so as to provide evidences for side crash or other accidents.

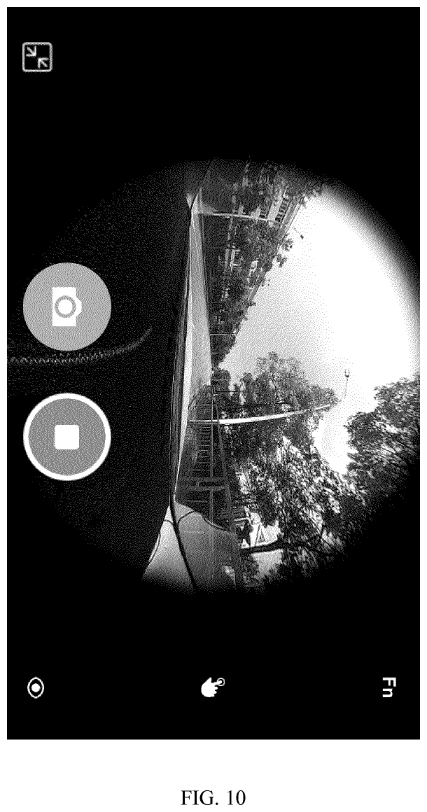

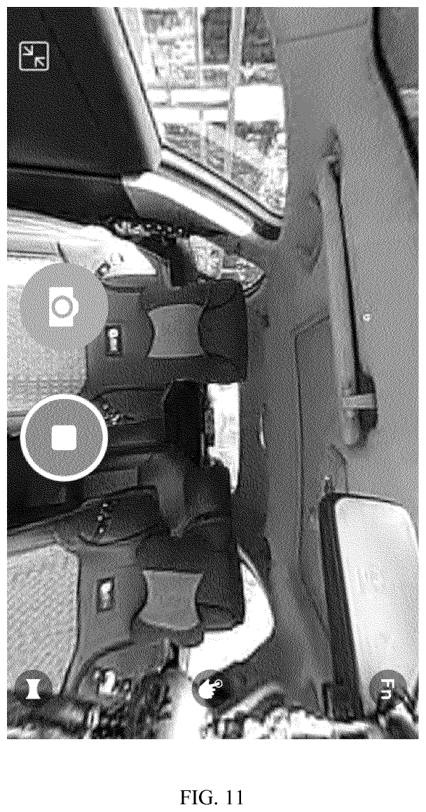

Alternatively or additionally, the application 906 comprises a user interface 9061, which is displayed on a displayer of the user equipment or of the automotive driving recorder as appropriate. Alternatively or additionally, the application, when executed, is configured to provide several choices of working modes. For example, in a private mode, only the front lens of the two lenses works and the interior part of the automobile will not be recorded, wherein the videos may be recorded for example with pixels of 1440*1440 and a frame rate of 30 fps. A full screen user interface in this working mode is shown in FIG. 10. Alternatively or additionally, in a virtual reality (VR) mode, both the lenses work and virtual reality videos are generated to facilitate VR viewing, wherein the videos may be recorded for example with pixels of 2880*1440 and a frame rate of 30 fps. As the VR views can only be rendered via a VR facility, the user interface in this working mode is not shown herein. Alternatively or additionally, in a speed mode, both the lenses work, and frame rate is raised, probably with a sacrifice of definition, for example, the videos may be recorded with pixels of 1440*720 and a frame rate of 60 fps. Alternatively or additionally, in a babyzoomer mode, although both the lenses work, only video data from the rear lens is rendered in the user interface, with a zoomed-in size, such as twice of original size. The videos in this working mode may be recorded for example with pixels of 2880*1440 and a frame rate of 30 fps. A full screen user interface in this working mode is shown in FIG. 11. Alternatively or additionally, in a normal mode, both the lenses work, and the videos in this working mode may be recorded for example with pixels of 2880*1440 and a frame rate of 30 fps.

It is noted that in all those modes with both the lenses working, exposure settings of the two lenses are determined by the two sensors respectively, so that both lenses can be well adapted to different lighting conditions outside and inside the automobile.

Alternatively or additionally, the automotive driving recorder comprises a storage 903, such as a storage card to be inserted into the storage card slot 008, or any other storage mounted in the body 910 of the automotive driving recorder, configured to store videos recorded from the front lens 001 and the rear lens 002. Generally, duration of recorded videos depend on volumes of the storage 903, for example, for a 32 GB MicroSD, 250 minutes videos with resolution of 2880*1440 and frame rate of 30 can be recorded. With the volume doubles, the duration doubles. When the storage is full, early videos will be erased and overwritten by new videos. In one example, there is an exception. The videos recorded in a case of emergency, for example, in response to an emergency trigger, such as detection of a traffic collision, pushing a button (the emergency button 006 as shown in FIG. 5) on the automotive driving recorder manually by a user and etc., can be for example stored in a separate folder that is kept away from being erased and overwritten, so that it can be stored on a long term basis, for example for future use as evidence. The traffic collision can be detected through an accelerometer 904 mounted in the body 910 of the automotive driving recorder.

Alternatively or additionally, the automotive driving recorder comprises a communication interface 905, configured to communicate the recorded videos to a user equipment wirelessly on which the application 906 runs. Protocols supported by the communication interface 905 comprise Wi-Fi, NFC, Bluetooth, and any other wireless protocols that can be used to facilitate data transmission between the body 910 of the automotive driving recorder and the user equipment. Once connected, date, time, languages, etc. can be synchronized from the user equipment to the body 910 of the automotive driving recorder via the communication interface 905.

Alternatively or additionally, the application 906, when executed, is configured to enable alerting based on driving fatigue index dependent on a series of physiological and journey related parameters such as time of the day and time spent on driving. The automotive driving recorder will alert the driver every two hours of driving. For example, when fatigue index is less than 60, the value is displayed in green color in the user interface 9061; before fatigue index reaches 80, yellow value is displayed in the user interface 9061 with an alert sound output from the body 910 of the automotive driving recorder via the loudspeaker 010 and/or the connected user equipment. When fatigue index is above 80, red value is displayed in the user interface 9061 with 3 alert sounds output from the body 910 of the automotive driving recorder and/or the connected user equipment. Alternatively or additionally, the alert may also comprise voice.

It is noted that in case that the application 906 is running in a user equipment connected with the body 910, the synchronized time can be used to assist determination of fatigue index and the synchronized languages can be used to determine the alert language.

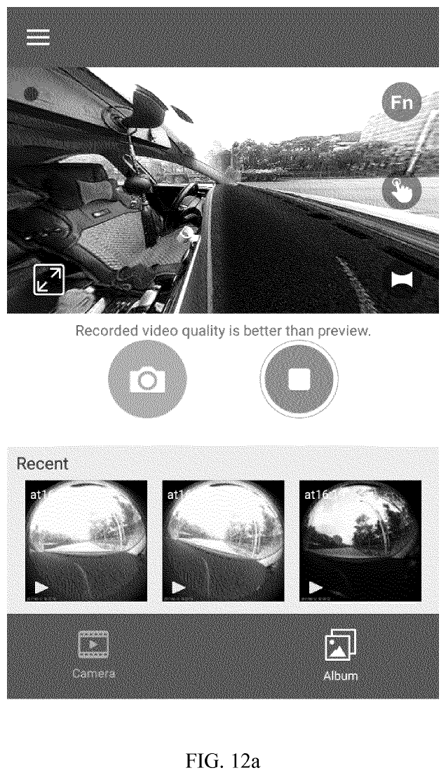

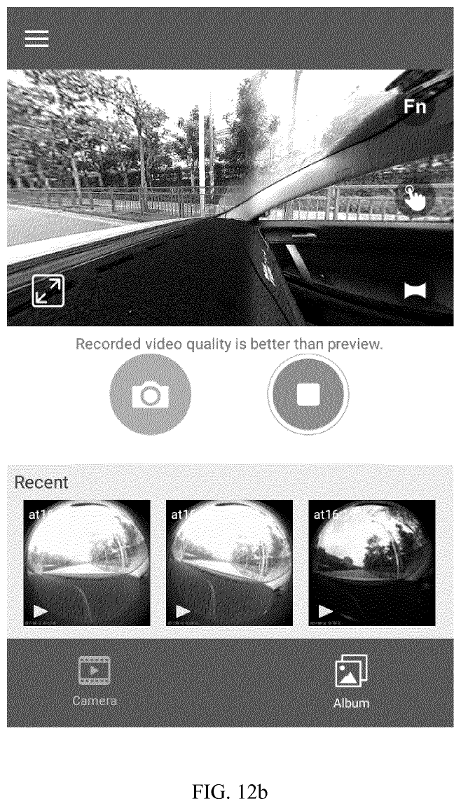

Alternatively or additionally, the application 906, when executed is configured to enable user viewing of the stitched videos from a desired field of view. The desired field of view can be chosen by positioning the connected user equipment towards a desired direction when the application 906 is executed in the user equipment connected to the body 910 of the automotive driving recorder, or by inputting requests via the user interface 9061 by the user. A normal user interface 9061 in a normal mode from a field of view of the co-pilot position is shown in FIG. 12a, and a normal user interface 9061 in a normal mode from a field of view of the driving position is shown in FIG. 12b.

According to our solution, videos are stitched to for a video of 360°, and views from desired fields of views in a driving scenario can be provided, so as to improve user experiences and enhance safe driving.

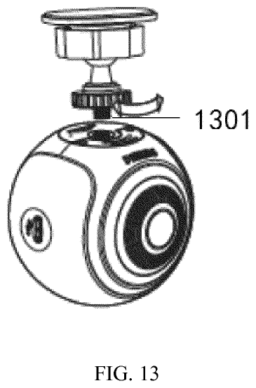

FIG. 13 illustrates an installation of the automotive driving recorder according to the embodiment of the present invention. In one example, the automotive driving recorder comprises a bracket 1301, which can be attached to the body 910 of the automotive driving recorder by screwing it securely to the screw socket 009.

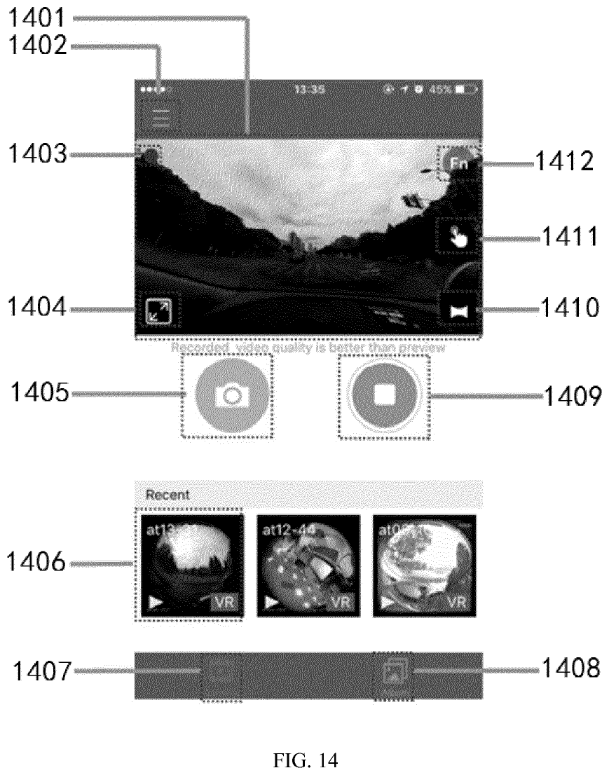

FIG. 14 illustrates a user interface 9061 of the automotive driving recorder according to the embodiment of the present invention. Live view display 1401 is configured to display live views from the body 910 of the automobile driving recorder. Menu 1402 comprises menu icon to be tapped to enter menu settings. Record status indicator 1403 shows icon blinks when recording starts. Full screen icon 1404 allows entering full screen when tapped. Camera icon 1405 allows photos taking when tapped. Recent video file 1406 allows the file to be replayed when tapped. Camera tab 1407 allows entering of a live view interface when tapped. Album tab 1408 allows entering of album when tapped. Start/stop play icon 1409 allows start or stop of recording when tapped. View projection 1410 is configured for the user to choose different angle of views, such as tiled view, fisheye view, or an angle similar to looking into a crystal ball, etc. Field of view 1411 allows the field of view of a video to change according to angle of the user equipment (if any) or inputs from the user, such as adjustments by the user's finger. Function mode icon 1412 allows choosing of different working modes when tapped, such as the normal mode, the VR mode, the speed mode, the privacy mode and the babyzoomer mode as discussed with reference to FIG. 9.

The stitched videos of 360° for an automobile driving recorder greatly help improve user experiences in both driving and reviewing.

Further, comparing to FIG. 1 of the prior art, FIGS. 12a and 12b show a greatly improved video quality with proper exposure settings at least for the front lens and the rear lens. One can see videos of the outside and also videos of the interior clearly.

While the embodiments have been illustrated and described herein, it will be understood by those skilled in the art that various changes and modifications may be made, and equivalents may be substituted for elements thereof without departing from the true scope of the present technology. In addition, many modifications may be made to adapt to a particular situation and the teaching herein without departing from its central scope. Therefore it is intended that the present embodiments are not limited to the particular embodiment disclosed as the best mode contemplated for carrying out the present technology, but that the present embodiments include all embodiments falling within the scope of the appended claims.

### LIST OF REFERENCE NUMERALS

001 first lens
002 second lens
003 interface, e.g., for power or data
004 wireless connection indicator
005 record status indicator
006 emergency recording button
007 microphone
008 storage card slot
009 screw socket
010 loudspeaker
901 first sensor
902 second sensor
903 storage
904 accelerometer
905 communication interface
906 application for stitching
910 body
1301 bracket
1401 live view display
1402 menu
1403 record status indicator
1404 full screen icon
1405 camera icon
1406 recent video file
1407 camera tab
1408 album tab
1409 start/stop play icon
1410 view projection
1411 field of view
1412 function mode icon
9061 user interface of application 906

1. An automotive driving recorder for being installed on an automobile, comprising:
a body;
a first lens mounted on a front portion of the body, facing in the forward direction of the automobile when installed to record first videos;
a second lens mounted on a rear portion of the body, facing in the backward direction of the automobile when installed to record second videos;
a first sensor, mounted in the body for sensing lighting conditions of the first lens; and
a second sensor, mounted in the body for sensing lighting conditions of the second lens independently from the first sensor,
wherein the automotive driving recorder is configured to
determine exposure settings of the first lens being adapted to the lighting conditions sensed by the first sensor, and
determine exposure settings of the second lens being adapted to the lighting conditions sensed by the second sensor independently from the determination of the exposure settings of the first lens.

2. The automotive driving recorder of claim 1, further comprising:
an application in communication with the body, for stitching the first videos and the second videos to form stitched videos of 360°.

3. The automotive driving recorder of claim 1, wherein the first lens and the second lens are wide-angle lenses.

4. The automotive driving recorder of claim 3, wherein an angle of the first lens or of the second lens or of the first and second lenses is 190°.

5. The automotive driving recorder of claim 1, wherein, in a private working mode, only the first lens of the two lenses works.

6. The automotive driving recorder of claim 1, wherein, in a virtual reality working mode, virtual reality videos are generated.

7. The automotive driving recorder of claim 1, wherein, in a babyzoomer mode, only the second videos are rendered, in a zoomed-in size.

8. The automotive driving recorder of claim 1, further comprising:
a storage, mounted in the body, capable of storing emergency videos that will not be overwritten by new videos automatically, in response to an emergency trigger.

9. The automotive driving recorder of claim 8, further comprising:
an emergency recording button on the body, when pushed, generating the emergency trigger.

10. The automotive driving recorder of claim 8, further comprising:
an accelerometer, mounted in the body, configured for detecting an automobile collision, and wherein, in response to such detecting, the emergency trigger is generated.

11. The automotive driving recorder of claim 1, further configured to enable alerting dependent on a driving fatigue index which is based on a series of physiological and journey related parameters.

12. The automotive driving recorder of claim 2, further comprising a communication interface on the body, and
wherein the application is run remotely on a user equipment which is independent from the body, and communicates with the body wirelessly via the communication interface.

13. The automotive driving recorder of claim 12, wherein the application comprises a user interface displayed on the user equipment, where a user can choose to view the stitched videos in a desired field of view.

14. The automotive driving recorder of claim 13, wherein the choosing is done by pointing the user equipment towards a direction, or by inputting requests via the user interface by the user.
